(19) United States
(12) Patent Application Publication
(10) Pub. No.: US 2008/0010880 A1
(43) Pub. Date: Jan. 17, 2008

(54) Clothing Item or Accessory for the Targeted Displaying of a Message

(76) Inventors: Frederic A. Maire, Athis Nons (FR); Jean-Michel Husson, Sainte Foy Les Lyon (FR)

Correspondence Address: OLIFF & BERRIDGE, PLC, P.O. BOX 320850, ALEXANDRIA, VA, 22320-4850, US

(21) Appl. No.: 11/596,538

(22) PCT Filed: May 17, 2005
(86) PCT No.: PCT/FR05/01220

§ 371 Date: Dec. 20, 2006

(30) Foreign Application Priority Data
May 18, 2004 (FR) 0405389

(51) Int. Cl. G09F 21/02

(52) U.S. Cl. 40/586; 40/547

(57) ABSTRACT

The invention concerns a clothing article (1) comprising display means (2) monitored by a control system including means for receiving a remotely transmitted information. The invention is characterized in that the control system comprises means for storing hierarchized identification data (I1, I2, I3) and filtering means adapted to compare at least part of the hierarchized identification data with addressing data (A1, A2, A3) likewise hierarchized contained in the received information.

The present invention relates, on the one hand, to an item of clothing including display means controlled by a control system comprising means for receiving an item of information transmitted remotely, and on the other hand, to a method for the displaying of information by the display means of such an item of clothing.

Shirts, T-shirts, bags, which are each equipped with an optical fiber screen for displaying a message are already known. The message displayed is programmable and can easily be modified from a wireless terminal, such as a mobile telephone, communicating with the control unit of the garment.

Data can be sent to this type of terminal indifferently, i.e. any item of clothing of this type present in the coverage area will react if it is tuned to the correct receive frequency, but it is also possible to provide for a point-to-point transmission mode by allocating an identification number to the item of clothing. In the latter case, only the item aimed at will react and it will not be possible to simultaneously transmit a message intended for several terminals having different identifiers. For example, when a transmitter sends a message intended for such an item of clothing, this transmitter encodes the number of the recipient clothing item and only this item reacts to the message. To reach another item of clothing, it will be necessary to retransmit the message with the appropriate identification number.

It is of course possible to group the terminals by allocating the same identifier to several items of clothing. In that case, all these terminals will receive the message but individualization will no longer be possible.

Certain means, such as for example the mailing lists of electronic messaging systems, provide for sending a message to several recipients having different identifiers. However, in practice this means sending several times as many point-to-point messages as there are recipients.

The present invention aims to remedy the abovementioned drawbacks, and to this end comprises an item of clothing including display means controlled by a control system comprising means for receiving an item of information transmitted remotely, characterized in that said control system additionally comprises, on the one hand, means for storing hierarchical identification data, and on the other hand, filtering means able to compare at least a part of the hierarchical identification data with addressing data, also hierarchical, contained in the received information.

Thus, by virtue of the storing of a plurality of identification data items and the presence of filtering means, it is possible to sort recipients according to several criteria. Since the data items are hierarchical, the filtering is carried out in a predetermined order thereby providing for varying the number of these criteria actually used with respect to the total number of identification data items and consequently providing for adapting the identification level. By allocating, to the control unit of the item of clothing, identification data representing groups to which this item of clothing belongs, in particular according to the characteristics of the wearer, it is possible, by transmitting only one item of information, to activate specifically the items of clothing belonging to the desired group or to several groups cumulatively.

Moreover, it must be clearly understood that the term item of clothing includes not only garments but also accessories such as glasses, caps, bags and others.

Advantageously, the hierarchical identification data items are programmable. It is clearly possible to preprogram the identification data. However, the fact that users can program their own identification data introduces much greater usage flexibility to the device.

Preferably, the item of clothing is a shirt-type sports garment.

Also preferably, the display means comprise at least one screen for displaying messages.

Preferably, the display means are implemented using optical fibers. These fibers can be discretely integrated in the fibers of the material of the item of clothing.

The present invention also includes a method for the display of information by the display means of an item of clothing, as described previously, characterized in that it comprises the following steps:
transmission of information containing hierarchical addressing data,
reception of the information by the receive means of the item of clothing,
transmission of the received information to the filtering means of the control system of the item of clothing,
filtering of the information by hierarchical comparison of the addressing data contained in the information with the identification data contained in the control system,
activation of the display means if necessary.

Advantageously, the display means is activated if the identification data items and the addressing data items compared are identical.

Preferably, if an identification data item and/or an addressing data item codes for a null value, these two data items are not compared with each other.

Thus, it is possible to deliberately ignore certain data identifying certain groups, and to deliver the message to all the items of clothing according to the invention, regardless of the values of these data items. This feature provides for ignoring a hierarchically superior group, or parent group, to which the items of clothing belong in order to test only the identity of the identification and addressing data relating to the child groups. Terminals belonging to several different parents groups will therefore be able to react in the same way. This feature provides for overriding, to a certain extent, the order of hierarchy by allowing some switching between the parent groups and the child groups.

Also preferably, the identification data items and the addressing data items, placed hierarchically after the data item coding for a null value, are not compared with each other. Thus, it is possible to test only a certain number of identification data items rather than all of them.

Advantageously, the information is transmitted in RDS mode.

The implementation of the invention will be more clearly understood with the aid of the detailed description set out below with reference to the accompanying drawings in which:

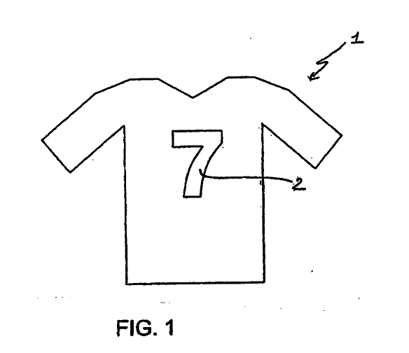

FIG. 1 is a simplified view of a shirt according to the invention;

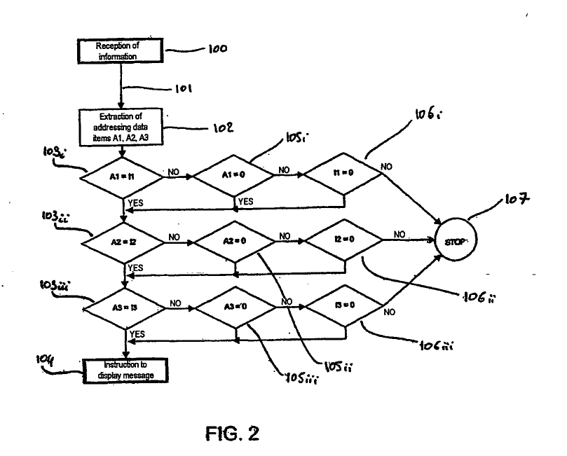

FIG. 2 is a schematic representation of the steps of a method according to the invention.

An item of clothing according to the invention, such as a football shirt 1 like the one represented in FIG. 1 for example, comprises, on the one hand, display means 2 such as a display screen implemented using optical fibers, and on the other hand, a control unit (not represented) able to control the display of a message on the screen via optical fibers.

Advantageously, the screen will be able to be adapted to reproduce the number written on the shirt.

Furthermore, this control unit includes receive means, preferably radio means, enabling it to receive information transmitted remotely, for example in the RDS format. A receive antenna will easily be able to be inserted in the cloth fibers of the shirt. The control unit will also be miniaturized as much as possible in order to be as discrete as possible and as small as possible.

The control unit also comprises means for storing identification data. These means can be of the electronic memory type or be presented as a series of multi-position switches.

A user wanting to use these shirts according to the invention will proceed as described below.

First, it is necessary to define groups, with which groups there will be associated an identification data item intended to receive a different value according to the group to which the wearer of the shirt belongs.

Taking the example of a football match, it is possible to distinguish between the following groups:
a first group, with which there is associated a first identification data item I1 and which will provide for distinguishing between the shirts worn by players, value 1, and shirts worn by spectators, value 2,
a second group, with which there is associated a second identification data item I2 and which will provide for distinguishing between the shirts of players or supporters according to whether the latter play for or support team 1 or team 2,
a third group, with which there is associated a third identification data item I3 and which will represent the number of the supported or real player for a given team.

All these identification data items form an identification field.

Each shirt wearer can program the desired values before the start of the match or it is even possible to provide preprogrammed shirts.

Additionally, provision will be made for the value 0 to code for the null value.

In order to proceed with displaying a message, it is necessary first to define the targets by determining addressing data, equivalent to the identification data, to which the desired values are assigned in order to then form an addressing field. The desired message is then added to the addressing field in accordance with the chosen transmission mode. By message, it must be clearly understood that it may if necessary be a simple instruction. Indeed, it is possible to provide prerecorded messages in a memory of the control unit and which are activated according to a predefined code.

The information, therefore comprising the addressing field and the message, is then transmitted in all directions.

Any shirt located in the coverage area picks up the transmitted information and will react according to the following steps.

Once received at a step 100, the information is transmitted, at a step 101, to the filtering means of the control unit. These latter proceed first with the extraction of addressing data items at a step 102, then with analyzing them. Each addressing data item A1, A2, A3 is compared at steps 103i, 103ii, 103iii with its corresponding identification data item I1, I2, I3 and in the order of the data items. If the addressing data item is identical to the identification data item, then the next addressing data item is compared with the next identification data item. If all the addressing data items are identical to their identification data items, then an instruction to display the message is sent at a step 104. It may involve for example instructing the screen 2 to be illuminated in the shape of the number that the shirt 1 bears.

Steps 105i, 105ii, 105iii and 106i, 106ii, 106iii are also provided in order to take into account null values of addressing and identification data items. Steps 105i, 105ii, 105iii send the method back to the normal sequence when the addressing data item A1, A2, A3 has a null value. Steps 106i, 106ii, 106iii do the same for the identification data items I1, I2, I3 when the addressing data item is null. If the identification data item is not null then the method is stopped 107.

These steps 105i, 105ii, 105iii and 106i, 106ii, 106iii provide for ignoring the corresponding group and for moving onto the analysis of the next identification and addressing data items.

For example, according to the groups defined previously, if it is desired to display a message on the shirt of player number 7 of team 1, the first addressing data item will have the value 1 (player), the second addressing data item will have the value 1 (for team 1), the third addressing data item will have the value 7 (player number 7). The addressing field will therefore be 1/1/7. In this example, all the identification data items have a value. Only the shirt having an identification field equal to 1/1/7 will display the message. For that shirt, the method will therefore follow steps 100, 101, 102, 103i, 103ii, 103iii and 104. According to the steps described above, the shirts having an identification field equal to 0/1/7, 1/0/7 or 1/1/0 will also display the message. For the shirt having an identification field equal to 1/0/7, the method will follow steps 100, 101, 102, 103i, 103ii, 105ii, 103iii, 104. All the other shirts, such as for example a shirt having an identification field equal to 1/2/3, will not display the message and the method will follow, for that shirt, steps 100, 101, 102, 103i, 103ii, 105ii, 106ii, 107.

The method according to the invention also provides for, by sending only one item of information, targeting, for example, all the shirts worn by supporters of team 2. To achieve this, it will be sufficient for the addressing field to take the value 2/2/0. The method will therefore follow steps 100, 101, 102, 103i, 103ii, 103iii, 105iii, 104. Since the last addressing data item is ignored, all the shirts having an identification field equal to 2/2/x will display the message regardless of the value of x.

It is also possible to have a message displayed on all the shirts in a group, for example on the shirts of the two number-8 players or on the shirts of all the spectators supporting team 1. To achieve this, the addressing field must have the value 1/0/8 for the first case, and 2/1/0 for the second case. Since the second and third addressing data items are null values respectively, each of these data items will be ignored by the method during steps 105ii and 105iii respectively. All the shirts having an identification field equal to, for the first case, 1/x/8, i.e. 1/1/8 or 1/2/8, and 2/1/x for the second case, will react in order to display the message at step 104.

It must be clearly understood that the number of groups defined is not limited and can be adapted according to the needs of the user.

Although the invention has been described with reference to particular example embodiments, it is clear that the invention is not at all limited to these and that it includes all the equivalent techniques of the means described as well as their combinations if the latter fall within the scope of the invention.

1. An item of clothing (1) including display means (2) controlled by a control system comprising means for receiving an item of information transmitted remotely, characterized in that said control system comprises, on the one hand, means for storing hierarchical identification data (I1, I2, I3), and on the other hand, filtering means able to compare at least a part of the hierarchical identification data with addressing data (A1, A2, A3), also hierarchical, contained in the received information.

2. The item of clothing (1) as claimed in claim 1, characterized in that the hierarchical identification data items (I1, I2, I3) are programmable.

3. The item of clothing (1) as claimed in claim 1, characterized in that it is a shirt-type sports garment.

4. The item of clothing (1) as claimed in claim 1, characterized in that the display means (2) comprise at least one screen for displaying messages.

5. The item of clothing (1) as claimed in claim 1, characterized in that the display means (2) are implemented using optical fibers.

6. A method for the display of information by the display means (2) of an item of clothing (1) as claimed in claim 1, characterized in that it comprises the following steps:
transmission of information containing hierarchical addressing data (A1, A2, A3),
reception (100) of the information by the receive means of the item of clothing (1),
transmission (101) of the received information to the filtering means of the control system of the item of clothing,
filtering (103 to 106) of the information by hierarchical comparison of the addressing data contained in the information with the identification data (I1, I2, I3) contained in the control system,
activation (104) of the display means if necessary.

7. The method as claimed in claim 6, characterized in that the display means (2) are activated if the identification data items (I1, I2, I3) and the addressing data items (A1, A2, A3) compared are identical.

8. The method as claimed in claim 6, characterized in that, if an identification data item (I1, I2, I3) and/or an addressing data item (A1, A2, A3) codes for a null value, these two data items are not compared with each other.

9. The method as claimed in claim 8, characterized in that the identification data items (I1, I2, I3) and the addressing data items (A1, A2, A3), placed hierarchically after the data item coding for a null value, are not compared with each other.

10. The method as claimed in claim 6, characterized in that the information is transmitted in RDS mode.
